(19) United States
(12) Patent Application Publication
(10) Pub. No.: US 2013/0022412 A1
(43) Pub. Date: Jan. 24, 2013

(54) Food Grade USDA Abrasive Media Free Flow System

(71) Applicant: Robert Richard Matthews, Washington, DC (US)

(72) Inventor: Robert Richard Matthews, Washington, DC (US)

(21) Appl. No.: 13/184,508

(22) Filed: Jul. 18, 2011

(51) Int. Cl. B65G 53/34

(52) U.S. Cl. 406/122

(57) ABSTRACT

The Food Grade USDA Abrasive Media System is an aqueous slurry Food Grade USDA abrasive media or FDA Approved aqueous slurry toothpaste formula system, or differential pressurized variable control regulation closed-type Food Grade USDA abrasive media or FDA Approved toothpaste formula system. The aqueous slurry type system pumps aqueous slurry media from an aqueous slurry pump. The differential pressurized variable control regulation closed-type system utilizes negative pressurized air or drawing the media from a control valve. The hallmark of The Food Grade USDA Abrasive Media System is light and easy to operate opening the door to whole new market of customers to safely perform paint stripping and cleaning tasks. Efficiency of operation is acquired by way of diffusion, equal particle distribution, and the effective Food Grade USDA Abrasive Media System can compete against harmful paint thinners, petroleum distillates, and chemical cleaners.

### BACKGROUND OF THE INVENTION

The Food Grade USDA Abrasive Media System is a replacement for hazardous materials solvents, paint thinners, and chemicals. Solvents or petroleum distillates and paint thinners are categorized as carcinogens and hazardous materials. The Food Grade USDA Abrasive Media System is designed to safely clean parts and remove paint by mechanical means as opposed to hazardous chemicals.

Many of the abrasive hoppers on the market today are bulky, heavy, and are hard to operate. The Food Grade USDA Abrasive Media System is light and easy to use, opening the door to whole new market of customers to safely perform paint stripping and cleaning tasks.

### BRIEF SUMMARY OF THE INVENTION

The Food Grade USDA Abrasive Media System is simple in design, light, and easy to operate for many specific cleaning, coating removal applications. This system should find success as environmentally and health conscious consumers become aware of the risks of using hazardous materials. In addition to the consumer market this system can be applied to automotive and aerospace paint stripping industry providing and environmental incentive for business that is change for the better. The Food Grade USDA Abrasive Media System can apply FDA Approved toothpaste formula patents filed separately for dental and oral care subject to The American Dental Association ADA Seal of Acceptance Program.

### BRIEF DESCRIPTION OF THE SEVERAL VIEWS OF THE DRAWING FOLLOWS FIGS. 1 TO 8

FIG. 1—Food Grade abrasive media airtight plastic injection molded preformed gravity feed free flow hopper comprising lid with release valve, air filter, silica gel slots, and filtered air gravity feed outlet sizes may vary;

FIG. 2—Differential Pressurized Variable Control Regulation Abrasive Media System;

FIG. 3—Parallel Phase Differential Pressurized Variable Control Regulation Abrasive Media System;

FIG. 4—Standard nozzle measured in diameter sizes may vary with fine water suppressor;

FIG. 5—Encapsulated pressurized nozzle with fine water suppressor;

FIG. 6—Alternating encapsulated pressurized nozzle with fine water suppressor;

FIG. 7—Theoretical FIG. of Food Grade USDA Abrasive Media Free Flow System; and

FIG. 8—Differential Pressurized Variable Control Regulation Abrasive Media System with 4× expansion of Control Valve.

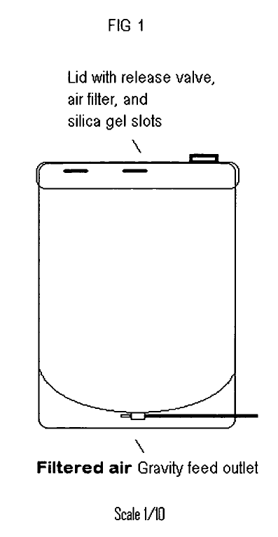

### DETAILED DESCRIPTION OF THE DRAWINGS FIGS. 1 TO 8

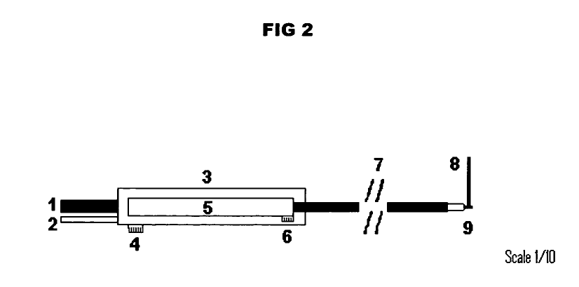

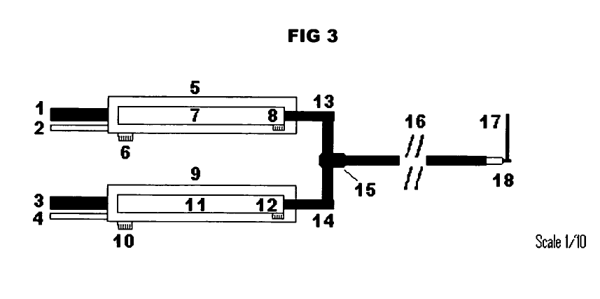

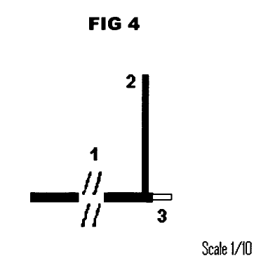

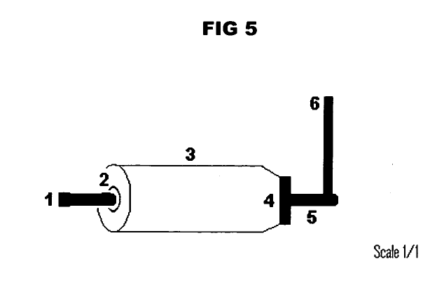

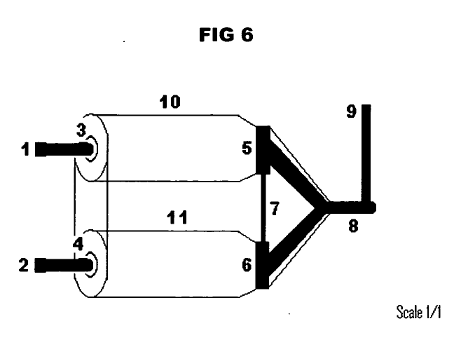

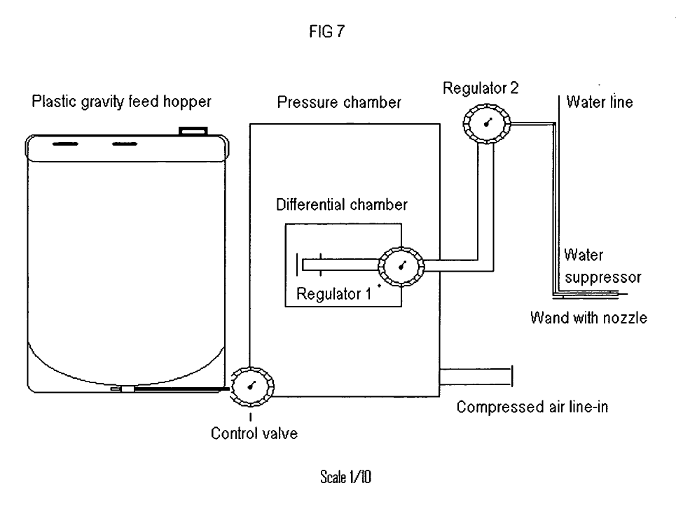

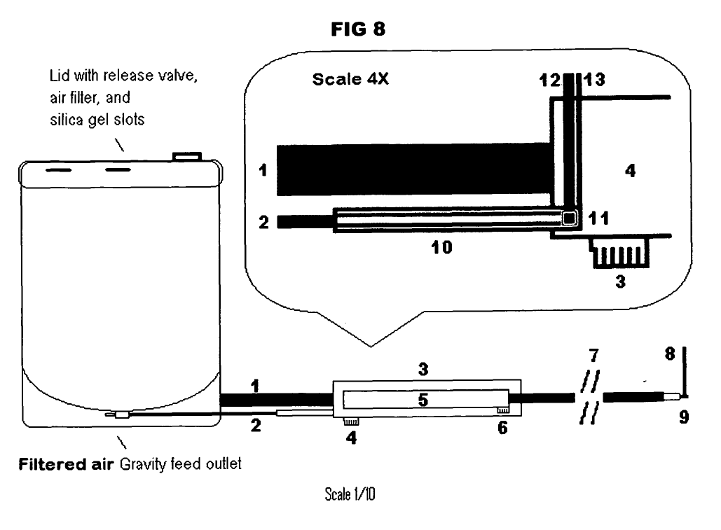

FIG. 1—Lid with release valve, air filter, silica gel slots, and filtered air gravity feed outlet, FIG. 2—1—Compressed air hose line-in measured in diameter, 2—Abrasive media hose line-in measured in diameter, 3—Outer pressurized chamber, 4—Variable control regulator, 5—Inner pressurized chamber, 6—Variable control regulator, 7—Compressed air and abrasive media hose line-out measured in diameter, 8—Water hose line-in measured in diameter fine water suppressor water ring or water ring delimited, and 9—Encapsulated nozzle, FIG. 3—1—Compressed air hose line-in measured in diameter, 2—Abrasive media hose line-in measured in diameter, 3—Compressed air hose line-in measured in diameter, 4—Abrasive media hose line-in measured in diameter, 5—Outer pressurized chamber, 6—Variable control regulator, 7—Inner pressurized chamber, 8—Variable control regulator, 9—Outer pressurized chamber, 10—Variable control regulator, 11—Inner pressurized chamber, 12—Variable control regulator, 13—Compressed air and abrasive media hose line-out 1 measured in diameter, 14—Compressed air and abrasive media hose line-out 2 measured in diameter, 15—Parallel phase regulator switch; elbow connectors; hose line-in measured in diameter, 16—Compressed air and abrasive media hose line-out 1-2 measured in diameter, 17—Water hose line-in measured in diameter fine water suppressor water ring or water ring delimited, and 18—Encapsulated nozzle, FIG. 4—1—Compressed air and abrasive media hose line-out measured in diameter, 2—Water hose line-in measured in diameter fine water suppressor water ring or water ring delimited, and 3—Standard nozzle measured in diameter sizes may vary, FIG. 5—1—Pressurized air and abrasive media hose line-in measured in diameter, 2—Encapsulated nozzle O-ring regulator pneumatic connector finite control, 3—Encapsulated nozzle pressurized chamber, 4—Encapsulated nozzle regulator 2 aperture measured in diameter, 5—Nozzle measured in diameter sizes may vary, and 6—Water hose line-in measured in diameter fine water suppressor water ring or water ring delimited, FIG. 6—1—Pressurized air and abrasive media hose line-in 1 measured in diameter, 2—Pressurized air and abrasive media hose line-in 2 measured in diameter, 3—Encapsulated nozzle O-ring regulator pneumatic connector finite control 1, 4—Encapsulated nozzle O-ring regulator pneumatic connector finite control 2, 5—Alternating encapsulated nozzle regulator 2 aperture 1 measured in diameter, 6—Alternating encapsulated nozzle regulator 2 aperture 2 measured in diameter, 7—Nozzle measured in diameter sizes may vary, 8—Water hose line-in measured in diameter fine water suppressor water ring or water ring delimited, 9—Pressurized chamber encapsulated nozzle 1, and 10—Pressurized chamber encapsulated nozzle 2, FIG. 7—Plastic gravity feed hopper, Control valve, Pressure chamber, Differential chamber, Regulator 1, Regulator 2, Compressed air line-in, Water line, Water suppressor, and Wand with nozzle, and FIG. 8—1—Compressed air hose line-in measured in diameter, 2—Abrasive media hose line-in measured in diameter, 3—Outer pressurized chamber, 4—Variable control regulator, 5—Inner pressurized chamber, 6—Variable control regulator, 7—Compressed air line-out measure in diameter; abrasive media hose line-out measured in diameter, 8—Water hose line-in measured in diameter fine water suppressor water ring or water ring delimited, 9—Encapsulated nozzle, 10—Control valve abrasive media hose line-in measured in diameter, 11—Control valve, 12—Control valve abrasive media hose line-out measured in diameter, and 13—Variable compressed air regulator hose line-in measured in diameter control valve.

### DETAILED DESCRIPTION OF THE INVENTION

The Food Grade USDA Abrasive Media System is a mechanical means to safely clean, degrease, and coating removal from parts and substrates such as metals, alloys, copper, glass, unreinforced masonry URMs, stone, concrete, and asphalt. This is a light, easy to use, and extremely efficient air pressurized system that utilizes mechanical means Food Grade abrasive media water soluble, or non-water soluble, military specification—citric acid, food starch, and crushed walnut shells. The Food Grade USDA Abrasive Media System can apply FDA Approved toothpaste formula patents filed separately for dental and oral care subject to The American Dental Association ADA Seal of Acceptance Program.

All parts Food Grade USDA Abrasive Media System are built to specification towards the application specificity requirement and conform with the specified requirements to a unique ASTM International-Standards Worldwide identifier—sizes may vary.

Description of all parts making and using the same Food Grade USDA Abrasive Media System: 1. Food Grade and Fine Food Grade abrasive media airtight plastic injection molded preformed gravity feed free flow hopper comprising lid with release valve, air filter, silica gel slots, and filtered air gravity feed outlet; 2. Control valve, specification of negative pressurized air, specification of compressed air control, and specification of pneumatic hose line-in and line-out measured in diameter; 3. Specification pneumatic hose line-in measured in diameter, and specification of compressed air; 4. Outer pressurized chamber, specification of compressed air, and variable control regulator compressed air control; 5. Inner pressurized chamber, specification of compressed air, and variable control regulator compressed air control; 6. Specification pneumatic hose line-out measured in diameter; 7. Parallel phase regulator switch, specification of compressed air control, specification pneumatic hose line-in left and right measured in diameter, and elbow connectors left and right; 8. Encapsulated nozzle, specification of pressurized air, encapsulated nozzle O-ring regulator pneumatic connector finite control, encapsulated nozzle regulator 2 specification of compressed air regulated control, nozzle attachments measured in diameter, and aperture measured in diameter; or alternating encapsulated nozzle, alternating encapsulated nozzle two specifications of pressurized air, alternating encapsulated nozzle two O-ring regulators pneumatic connectors finite control, alternating encapsulated nozzle two regulators 2 specification of compressed air regulated control, nozzle attachments measured in diameter, and aperture measured in diameter; 9. Wand with nozzle; 10. Water suppressor supply of water hose line-in measured in diameter and fine water suppressor attachments water ring or water ring delimited; 11. Nozzle measured in diameter specification of pressurized stream.

The Food Grade abrasive media airtight plastic injection molded preformed gravity feed free flow hopper comprising lid with release valve, air filter, silica gel slots, and filtered air gravity feed outlet is utilized specially packaged closed recycled refilled preparation Food Grade abrasive media water soluble, or non-water soluble, military specification—citric acid, food starch, crushed walnut shells, or FDA Approved toothpaste formula patents filed separately.

The Food Grade abrasive media airtight plastic injection molded preformed gravity feed free flow hopper comprising lid with release valve, air filter, silica gel slots, and filtered air gravity feed outlet connects directly to the control valve FIG. 7.

Abrasive media or FDA Approved toothpaste formula is drawn into the abrasive media line-in measured in diameter by way of negative pressurized air, transported directly into the control valve, and projected freely into the pressure system whereby it reaches specification diffusion and achieves equal particle distribution.

After the abrasive media exits the encapsulated nozzle or standard nozzle there it can be suppressed by water to clean and remove contamination from the desired substrate.

This system comprising air pressurized chambers, variable control regulation, and a dual regulation standard. This is a non-venturi system. Differential pressurization is the process obtaining diffusion and equal particle distribution for more than one or two or more pressurized streams combined FIGS. 2, 3, and 7.

Differential pressurization is mathematically determined in cubic feet per minute CFM and pounds per square PSI of data sets from the following system: 1. Differential Pressurized Variable Control Regulation Abrasive Media System; specification air pressurization, control valve variable control regulation positive pressurization sum, and encapsulated nozzle specification 2 regulation or abrasive media standard nozzle measured in diameter specification of pressurized stream.

This system comprising an encapsulated nozzle for advanced efficiency of operation FIG. 5, a standard nozzle FIG. 4, and an alternating encapsulated pressurized nozzle for applications requiring two volumes of abrasive media FIG. 6.

With the addition of a parallel phase regulator switch this system can expand to operate parallel capacities of abrasive media for applications without interval when necessary FIG. 3.

1. The Food Grade USDA abrasive media system comprising an airtight plastic injection molded preformed gravity feed free flow hopper, lid with release valve, air filter, silica gel slots, gravity feed outlet connecting directly to control valve drawing abrasive media from negative pressurized air defining a proprietary closed type system.

2. The Food Grade USDA Abrasive Media closed type system utilizing differential pressurization variable control regulation and obtaining the process of diffusion, equal particle distribution, and differential pressurization as the process obtaining diffusion and equal particle distribution for more than one or two or more pressurized streams combined.

3. The Food Grade USDA abrasive media airtight plastic injection molded preformed gravity feed free flow hopper comprising a lid with release valve, air filter, silica gel slots, gravity feed outlet and is prepared specially packaged closed recycled refilled and utilized with Food Grade USDA abrasive media water soluble, or non-water soluble, military specification food starch, crushed walnut shells, and FDA Approved toothpaste formula for dental and oral care subject to The American Dental Association ADA Seal of Acceptance Program.

4. The Food Grade USDA Abrasive Media System can be expanded to operate parallel capacities of abrasive media by way of a parallel phase regulator switch.

5. The Food Grade USDA Abrasive Media System operates a standard abrasive media nozzles and proprietary encapsulated nozzles numbers 1. Standard abrasive media nozzle measured in diameter specification of pressurized stream; 2. Encapsulated nozzle, encapsulated nozzle pressurized chamber, encapsulated nozzle specification of pressurized air, encapsulated nozzle O-ring regulator pneumatic connector finite control, encapsulated nozzle regulator 2 specification of compressed air regulated control, nozzle attachments measured in diameter, and aperture measured in diameter; or 3. Alternating encapsulated nozzle two pressurized chambers, alternating encapsulated nozzle two specifications of pressurized air, alternating encapsulated nozzle two O-ring regulators pneumatic connectors finite control, alternating encapsulated nozzle two regulators 2 specification of compressed air regulated control, nozzle attachments measured in diameter, and apertures measured in diameter.

6. The Food Grade USDA Abrasive Media System applies FDA Approved toothpaste formula for dental and oral care subject to The American Dental Association ADA Seal of Acceptance Program.

7. All parts of the Food Grade USDA Abrasive Media System are built to specification towards the application specificity requirement sizes varying for description of all parts making and using the same Food Grade USDA Abrasive Media System 1. Food Grade abrasive media airtight plastic injection molded preformed gravity feed free flow hopper comprising lid with release valve, air filter, silica gel slots, and filtered air gravity feed outlet; 2. Control valve, specification of negative pressurized air, specification of compressed air control, and specification of pneumatic hose line-in and line-out measured in diameter; 3. Specification pneumatic hose line-in measured in diameter, and specification of compressed air; 4. Outer pressurized chamber, specification of compressed air, and variable control regulator compressed air control; 5. Inner pressurized chamber, specification of compressed air, and variable control regulator compressed air control; 6. Specification pneumatic hose line-out measured in diameter; 7. Parallel phase regulator switch, specification of compressed air control, specification pneumatic hose line-in left and right measured in diameter, and elbow connectors left and right; 8. Encapsulated nozzle, specification of pressurized air, encapsulated nozzle O-ring regulator pneumatic connector finite control, encapsulated nozzle regulator 2 specification of compressed air regulated control, nozzle attachments measured in diameter, and aperture measured in diameter; or alternating encapsulated nozzle, alternating encapsulated nozzle two specifications of pressurized air, alternating encapsulated nozzle two O-ring regulators pneumatic connectors finite control, alternating encapsulated nozzle two regulators 2 specification of compressed air regulated control, nozzle attachments measured in diameter, and aperture measured in diameter; 9. Wand with nozzle; 10. Water suppressor supply of water hose line-in measured in diameter and fine water suppressor attachments water ring or water ring delimited; 11. Nozzle measured in diameter specification of pressurized stream.
